(19) United States
(12) Patent Application Publication
(10) Pub. No.: US 2023/0221931 A1
(43) Pub. Date: Jul. 13, 2023

(54) AUTONOMOUS COMPUTE ELEMENT OPERATION USING BUFFERS

(71) Applicant: Ascenium, Inc., Campbell, CA (US)

(72) Inventor: Peter Foley, Los Altos Hills, CA (US)

(73) Assignee: Ascenium, Inc., Campbell, CA (US)

(21) Appl. No.: 18/124,115

(22) Filed: Mar. 21, 2023

Related U.S. Application Data
(63) Continuation-in-part of application No. 17/963,226, filed on Oct. 11, 2022.
Application No. 17/963,226 is a continuation-in-part of application No. 17/526,003, filed on Nov. 15, 2021.
Application No. 17/526,003 is a continuation-in-part of application No. 17/465,949, filed on Sep. 3, 2021.
(60) Provisional application No. 63/447,915, filed on Feb. 24, 2023.
(60) Provisional application No. 63/442,131, filed on Jan. 31, 2023.
(60) Provisional application No. 63/424,960, filed on Nov. 14, 2022.
(60) Provisional application No. 63/424,961, filed on Nov. 14, 2022.
(60) Provisional application No. 63/402,490, filed on Aug. 31, 2022.
(60) Provisional application No. 63/400,087, filed on Aug. 23, 2022.
(60) Provisional application No. 63/393,989, filed on Aug. 1, 2022.
(60) Provisional application No. 63/388,268, filed on Jul. 12, 2022.
(60) Provisional application No. 63/357,030, filed on Jun. 30, 2022.
(60) Provisional application No. 63/340,499, filed on May 11, 2022.
(60) Provisional application No. 63/322,245, filed on Mar. 22, 2022.
(60) Provisional application No. 63/318,413, filed on Mar. 10, 2022.
(60) Provisional application No. 63/295,544, filed on Dec. 31, 2021.
(60) Provisional application No. 63/254,557, filed on Oct. 12, 2021.
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.

(51) Int. Cl. G06F 8/41

(52) U.S. Cl. CPC G06F 8/433

(57) ABSTRACT

Techniques for task processing based on autonomous compute element operation using buffers are disclosed. A two-dimensional array of compute elements is accessed. Each compute element is known to a compiler and is coupled to its neighboring compute elements within the array of compute elements. Control is provided for the array of compute elements on a cycle-by-cycle basis. The control is enabled by a stream of wide control words generated by the compiler. An autonomous operation buffer is loaded with at least two operations contained in control words. The autonomous operation buffer is integrated in a compute element. A compute element operation counter coupled to the autonomous operation buffer is set. The compute element operation counter is integrated in the compute element. The at least two operations are executed using the autonomous operation buffer and the compute element operation counter. The operations complete autonomously from direct compiler control.

### RELATED APPLICATIONS

This application claims the benefit of U.S. Provisional Pat. Applications “Autonomous Compute Element Operation Using Buffers” Ser. No. 63/322,245, filed Mar. 22, 2022, “Parallel Processing Of Multiple Loops With Loads And Stores” Ser. No. 63/340,499, filed May 11, 2022, “Parallel Processing Architecture With Split Control Word Caches” Ser. No. 63/357,030, filed Jun. 30, 2022, “Parallel Processing Architecture With Countdown Tagging” Ser. No. 63/388,268, filed Jul. 12, 2022, “Parallel Processing Architecture With Dual Load Buffers” Ser. No. 63/393,989, filed Aug. 1, 2022, “Parallel Processing Architecture With Bin Packing” Ser. No. 63/400,087, filed Aug. 23, 2022, “Parallel Processing Architecture With Memory Block Transfers” Ser. No. 63/402,490, filed Aug. 31, 2022, “Parallel Processing Using Hazard Detection And Mitigation” Ser. No. 63/424,960, filed Nov. 14, 2022, “Parallel Processing With Switch Block Execution” Ser. No. 63/424,961, filed Nov. 14, 2022, “Parallel Processing With Hazard Detection And Store Probes” Ser. No. 63/442,131, filed Jan. 31, 2023, and “Parallel Processing Architecture For Branch Path Suppression” Ser. No. 63/447,915, filed Feb. 24, 2023.

This application is also a continuation-in-part of U.S. Pat. Application “Load Latency Amelioration Using Bunch Buffers” Ser. No. 17/963,226, filed Oct. 11, 2022, which claims the benefit of U.S. Provisional Pat. Applications “Load Latency Amelioration Using Bunch Buffers” Ser. No. 63/254,557, filed Oct. 12, 2021, “Compute Element Processing Using Control Word Templates” Ser. No. 63/295,544, filed Dec. 31, 2021, “Highly Parallel Processing Architecture With Out-Of-Order Resolution” Ser. No. 63/318,413, filed Mar. 10, 2022, “Autonomous Compute Element Operation Using Buffers” Ser. No. 63/322,245, filed Mar. 22, 2022, “Parallel Processing Of Multiple Loops With Loads And Stores” Ser. No. 63/340,499, filed May 11, 2022, “Parallel Processing Architecture With Split Control Word Caches” Ser. No. 63/357,030, filed Jun. 30, 2022, “Parallel Processing Architecture With Countdown Tagging” Ser. No. 63/388,268, filed Jul. 12, 2022, “Parallel Processing Architecture With Dual Load Buffers” Ser. No. 63/393,989, filed Aug. 1, 2022, “Parallel Processing Architecture With Bin Packing” Ser. No. 63/400,087, filed Aug. 23, 2022, and “Parallel Processing Architecture With Memory Block Transfers” Ser. No. 63/402,490, filed Aug. 31, 2022.

The U.S. Pat. Application “Load Latency Amelioration Using Bunch Buffers” Ser. No. 17/963,226, filed Oct. 11, 2022 is also a continuation-in-part of U.S. Pat. Application “Highly Parallel Processing Architecture With Compiler” Ser. No. 17/526,003, filed Nov. 15, 2021, which claims the benefit of U.S. Provisional Pat. Applications “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

The U.S. Pat. Application “Highly Parallel Processing Architecture With Compiler” Ser. No. 17/526,003, filed Nov. 15, 2021 is also a continuation-in-part of U.S. Pat. Application “Highly Parallel Processing Architecture With Shallow Pipeline” Ser. No. 17/465,949, filed Sep. 3, 2021, which claims the benefit of U.S. Provisional Pat. Applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to task processing and more particularly to autonomous compute element operation using buffers.

### BACKGROUND

Data is among the most valuable assets of any organization, irrespective of its organizational size. The organizations go to extraordinary lengths to obtain, maintain, organize, store, process, access, and protect their data. And in pursuit of that data, the organizations expend substantial financial, human, and physical resources. Effective data processing and protection directly contribute to organizational success, while ineffective processing wastes resources and squanders competitive opportunities. The effective data processing handles large, diverse, and often unstructured datasets. The processing of the data supports commercial, educational, governmental, medical, research, or retail organizations, and forensic or law enforcement agencies. Computational resources are purchased, configured, deployed, and maintained by the organizations to meet data processing needs. The resources include processors, networking and communications equipment, data storage units, HVAC equipment, power conditioning units, backup power units, and telephony, among other essential equipment. Computational resources consume prodigious amounts of energy and produce copious heat, necessitating critical energy resource management. The computational resources can be housed in special-purpose, secure installations that can resemble high-security compounds or even vaults rather than traditional office buildings. While not every organization requires vast computational equipment installations, all strive to provide and use their resources to meet their data processing needs.

The organizations execute many and various processing jobs. The processing jobs include running billing and payroll, generating profit and loss statements, processing tax returns or election results, controlling experiments, analyzing research data, and generating academic grades, among others. The processing jobs consume computational resources in installations that typically operate 24×7×365. The types of data processed derive from the organizational missions. These processing jobs must be executed quickly, accurately, and cost-effectively. The processed datasets can be very large and unstructured, thereby saturating conventional computational resources. Processing an entire dataset may be required to find a particular data element. Effective dataset processing enables rapid and accurate identification of potential customers, or finetuning production and distribution systems, among other results that yield a competitive advantage to the organization. Ineffective process wastes money by losing sales or failing to streamline a process, thereby increasing costs.

Organizations accumulate their data by implementing various data collection techniques. Ideally, the data is collected from a wide diversity of individuals. “Opt-in” data collection techniques invite an individual to sign up, create an account, register, or otherwise actively and willingly agree to participate in the data collection. Governmental or legislative data collection techniques require citizens to obtain a registration number and provide certain information to interact with government agencies, law enforcement, emergency services, and others. Covert, hidden, or illegal techniques also exist. These latter techniques collect data from unwitting individuals as they make purchases, visit various websites, and select menu choices, among other activities. Data has also been collected by theft, social engineering ploys, and extortion. Whatever the data collection techniques used, the collected data is highly valuable to the organizations if processed rapidly and accurately.

### SUMMARY

Institutions of all types support their organizational missions by performing large numbers of processing jobs. Timely and efficient execution of the processing jobs is essential because any one of the processing jobs can be deemed mission critical. The types of jobs that are typically processed include billing, running payroll, analyzing research data, or training a neural network for machine learning, among many others. These processing jobs are highly complex and are frequently based on the successful completion of many tasks. The tasks can include loading and storing various datasets, accessing processing components and systems, executing data processing, and so on. The tasks are typically built from subtasks that themselves can be complex. The subtasks are often used to handle specific data-related jobs such as loading data from storage; performing arithmetic computations, logic evaluations, and other manipulations of the data; transferring the results back to storage; handling inter-subtask communication such as data transfer and control; and so on. The datasets that are accessed are often vast in size and can easily overwhelm traditional data processing architectures. Processing architectures that are either ill-suited to the processing tasks or inflexible in their designs simply cannot manage the data handing and computation tasks.

To greatly improve task processing efficiency and data throughput, the tasks and subtasks can be processed using two-dimensional (2D) arrays of elements. The 2D arrays include compute elements, multiplier elements, registers, caches, queues, register files, buffers, controllers, decompressors, arithmetic logic units (ALUs), storage elements, scratchpads, and other components. The components can communicate among themselves to exchange instructions, data, signals, and so on. These arrays of elements are configured and operated by providing control to the array of elements on a cycle-by-cycle basis. The control of the 2D array is accomplished by providing control words generated by a compiler. The control includes a stream of control words, where the control words can include wide microcode control words generated by the compiler. The control words can comprise variable length control words. The variable length can be a result of a run-length type encoding technique, which can exclude, for example, information for array resources that are not used. Each control word can include, at the start of the control word, an offset to the next control word, which makes this type of variable length encoding efficient from a fetch and decompress pipeline standpoint.

At least two operations contained within a control word are loaded into an autonomous operation buffer. Additional autonomous operation buffers can also be loaded with at least two operations. The autonomous operation buffers are integrated in compute elements. A compute element operations counter, which is set, is coupled to the autonomous operation buffer. The compute element operations counter is integrated in the compute element. The operations in the autonomous operation buffer are used to configure the array and to control the flow or transfer of data and the processing of the tasks and subtasks. The compute element operation counter tracks the “cycling through” the autonomous operation buffer. The autonomous operation buffer can be cycled through a number of times to accomplish operations iteratively, repeatedly, on substantially similar operations of blocks of data (e.g., single instruction multiple data (SIMD) operations), etc. The tracking of the cycling can accomplish operations looping. The operations looping can accomplish dataflow processing within statically scheduled compute elements. The array of compute elements can be configured in a topology which is best suited to the task processing. The topologies into which the arrays can be configured include a systolic, a vector, a cyclic, a spatial, a streaming, or a Very Long Instruction Word (VLIW) topology, among others. The topologies can include a topology that enables machine learning functionality. A task completion signal is generated based on a value in the compute element operation counter.

A processor-implemented method for task processing is disclosed comprising: accessing a two-dimensional (2D) array of compute elements, wherein each compute element within the array of compute elements is known to a compiler and is coupled to its neighboring compute elements within the array of compute elements; providing control for the array of compute elements on a cycle-by-cycle basis, wherein the control is enabled by a stream of wide control words generated by the compiler; loading an autonomous operation buffer with at least two operations contained in one or more control words, wherein the autonomous operation buffer is integrated in a compute element; setting a compute element operation counter, coupled to the autonomous operation buffer, wherein the compute element operation counter is integrated in the compute element; and executing the at least two operations, using the autonomous operation buffer and the compute element operation counter, wherein the operations complete autonomously from direct compiler control. Some embodiments comprise grouping a subset of compute elements within the array of compute elements. In embodiments, the subset comprises compute elements that are adjacent to at least two other compute elements within the array of compute elements. Some embodiments comprise loading additional autonomous operation buffers with additional operations contained in the one or more control words. Further, some embodiments comprise setting additional compute element operation counters, each coupled to an autonomous operation buffer of the additional operation buffers.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for autonomous compute element operation using buffers.

FIG. 2 is a flow diagram for buffer control and completion signal generation.

FIG. 3 is a system block diagram for a compute element.

FIG. 4 illustrates a system block diagram for a highly parallel architecture with a shallow pipeline.

FIG. 5 shows compute element array detail.

FIG. 6 illustrates a system block diagram for compiler interactions.

FIG. 7 is a system diagram for autonomous compute element operation using buffers.

### DETAILED DESCRIPTION

Techniques for autonomous compute element operation using buffers are disclosed. In an architecture such as an architecture based on configurable compute elements as described herein, the loading of data, control words, compute element operations, control word “bunches”, and so on can cause execution of a process, task, subtask, and the like to stall operations in the array. The stalling can cause execution of a single compute element to halt or suspend, which requires the entire array to stall, because the hardware must be kept in synchronization with compiler expectations on an architectural cycle basis, described later. The halting or suspending can continue while needed data is stored or fetched or completes operation. The compute element array as a whole stalls if external memory cannot supply data in time, or if a new control word cannot be fetched and/or decompressed in time, for example. In addition, a multicycle, nondeterministic duration operation in a multicycle element (MEM), such as a divide operation, may take longer than scheduled, in which case the compute element array would have to stall while waiting for the MEM operation to complete (when that result is to be taken into the array as an operand). Noted throughout, control for the array of compute elements is provided on a cycle-by-cycle basis. The control can be based on one or more sets of control words. The control words can include short words, long words, and so on. The control that is provided to the array of compute elements is enabled by a stream of wide control words generated by a compiler. The control words can be variable length. The compiler can include a general-purpose compiler, a hardware description compiler, a specialized compiler, etc. The control words comprise compute element operations. The control words can be variable length, as described by the architecture, or they can be fixed length. However, a fixed length control word can be compressed, which can result in variable lengths for operational usage to save space. At least two operations that can be contained in one or more control words can be loaded into buffers. The buffers can include autonomous operation buffers. The control words can include control word bunches. The control word bunches provide operational control of a particular compute element. The control word bunches can be loaded into the autonomous operation buffer. Additional autonomous operation buffers can be loaded with additional operations contained in the one or more control words. The autonomous operation buffer and the additional autonomous operation buffers are integrated into one or more compute elements. The control word bits provide operational control for the compute element. In addition to providing control to the compute elements within the array, data can be transferred or “preloaded” into caches, registers, and so on prior to executing the tasks or subtasks that process the data.

The buffers for storing bunches of control words can be based on storage elements, registers, etc. The registers can be based on a memory element with two read ports and one write port (2R1W). The 2R1W memory element enables two read operations and one write operation to occur substantially simultaneously. A plurality of buffers based on a 2R1W register is distributed throughout the array. The bunches of control words can be written to one or more buffers associated with each compute element within the 2D array of compute elements. The bunches can configure the compute elements, enable the compute elements to execute operations autonomously within the array, and so on. The control word bunches can include a number of operations that can accomplish some or all of the operations associated with a task, a subtask, and so on. Two or more compute element operations contained in one or more control words can be loaded into an autonomous operation buffer. The compute element operations or additional compute element operations can be loaded into additional autonomous operation buffers. By providing a sufficient number of operations into the operation buffer, autonomous operation of the compute element can be accomplished. The autonomous operation of the compute element can be based on the compute element operation counter keeping track of cycling through the autonomous operation buffer. The keeping track of cycling through the autonomous operation buffer is enabled without additional control word loading into the buffers. Recall that latency associated with access by a compute element to storage, that is, memory external to a compute element or to the array of compute elements, can be significant and can cause the compute element array to stall. By performing operations without additional loading of control words, control word load latency can be eliminated, thus expediting the execution of operations.

Tasks and subtasks that are executed by the compute elements within the array of compute elements can be associated with a wide range of applications. The applications can be based on data manipulation, such as image, video, or audio processing applications; AI applications; business applications; data processing and analysis; and so on. The tasks that are executed can perform a variety of operations including arithmetic operations, shift operations, logical operations including Boolean operations, vector or matrix operations, tensor operations, and the like. The subtasks can be executed based on precedence, priority, coding order, amount of parallelization, data flow, data availability, compute element availability, communication channel availability, and so on.

The data manipulations are performed on a two-dimensional (2D) array of compute elements (CEs). The compute elements within the 2D array can be implemented with central processing units (CPUs), graphics processing units (GPUs), application specific integrated circuits (ASICs), field programmable gate arrays (FPGAs), processing cores, or other processing components or combinations of processing components. The compute elements can include heterogeneous processors, homogeneous processors, processor cores within an integrated circuit or chip, etc. The compute elements can be coupled to local storage, which can include local memory elements, register files, cache storage, etc. The cache, which can include a hierarchical cache such as an L1, L2, and L3 cache, can be used for storing data such as intermediate results, compressed control words, coalesced control words, decompressed control words, compute element operations, relevant portions of a control word, and the like. The cache can store data produced by a taken branch path, where the taken branch path is determined by a branch decision. The decompressed control word is used to control one or more compute elements within the array of compute elements. Multiple layers of the two-dimensional (2D) array of compute elements can be “stacked” to comprise a three-dimensional array of compute elements.

The tasks, subtasks, etc., that are associated with processing operations are generated by a compiler. The compiler can include a general-purpose compiler, a hardware description-based compiler, a compiler written or “tuned” for the array of compute elements, a constraint-based compiler, a satisfiability-based compiler (SAT solver), and so on. Control is provided to the hardware in the form of control words, where one or more control words are generated by the compiler. The control words are provided to the array on a cycle-by-cycle basis. The control words can include wide, variable length, microcode control words. The length of a microcode control word can be adjusted by compressing the control word. The compressing can be accomplished by recognizing situations where a compute element is unneeded by a task. Thus, control bits within the control word associated with the unneeded compute elements are not required for that compute element. Other compression techniques can also be applied. The control words can be used to route data, to set up operations to be performed by the compute elements, to idle individual compute elements or rows and/or columns of compute elements, etc. Noting that the compiled microcode control words that are generated by the compiler are based on bits, the control words can be compressed by selecting bits from the control words. Compute element operations contained in one or more control words from a number of control words can be loaded into one or more autonomous operation buffers. The contents of the buffers provide control to the compute elements. The control of the compute elements can be accomplished by a control unit. Thus, in general, the hardware is completely under compiler control, which means that the hardware and the operation of the hardware-particularly the operation of any given compute element—is controlled on a cycle-by-cycle basis by compiler-generated control words driven into the array of compute elements by a control unit. However, local, compute element autonomous operation can be enabled using buffers, which can be described as “bunch buffers”.

Autonomous compute element operation using buffers enables task processing. The task processing can include data manipulation. A two-dimensional (2D) array of compute elements is accessed. The compute elements can include compute elements, processors, or cores within an integrated circuit; processors or cores within an application specific integrated circuit (ASIC); cores programmed within a programmable device such as a field programmable gate array (FPGA); and so on. The compute elements can include homogeneous or heterogeneous processors. Each compute element within the 2D array of compute elements is known to a compiler. The compiler, which can include a general-purpose compiler, a hardware-oriented compiler, or a compiler specific to the compute elements, can compile code for each of the compute elements. Each compute element is coupled to its neighboring compute elements within the array of compute elements. The coupling of the compute elements enables data communication between and among compute elements. Thus, the compiler can control data flow between and among the compute elements and can further control data commitment to memory outside of the array.

The array of compute elements is controlled on a cycle-by-cycle basis, wherein the controlling is enabled by a stream of wide control words generated by the compiler. A cycle can include a clock cycle, an architectural cycle, a system cycle, etc. The stream of wide control words generated by the compiler provides direct, fine-grained control of the 2D array of compute elements. The fine-grained control can include control of individual compute elements, memory elements, control elements, array bus resources, etc. An autonomous operation buffer is loaded with at least two operations contained in one or more control words. Additional autonomous operation buffers can be loaded with additional operations contained in the one or more control words. A control word can include a control word with control word bunches. The control word bunches can provide operational control of a particular compute element. The autonomous operation buffer is integrated in a compute element. The buffer and the additional buffers can be used to store a number of sets of control word bunches. The bunches of control words can enable autonomous compute element operation. Control words contain operations that span the array of compute elements; control word bunches span only a given compute element. Thus, one entry of a bunch buffer represents only a small part of a control word. The autonomous operation can be based on setting a compute element operation counter. The compute element operation is coupled to the autonomous operation buffer. The counter is integrated in the compute element. Additional compute element operation counters can be set. Each counter can be coupled to an autonomous operation buffer of additional operation buffers. The compute element operation counter and the additional compute element operation counters track cycling through the autonomous operation buffer. At least two operations are executed using the autonomous operation buffer and the compute element operation counter. The operations complete autonomously from compiler (i.e., control word) control. A task completion signal is generated based on a value in the compute element operation counter. It is to be understood that when running autonomously out of its own bunch buffer, a compute element is temporarily not controlled on a cycle-by-cycle basis by control words that may still be issued into the array by the control unit.

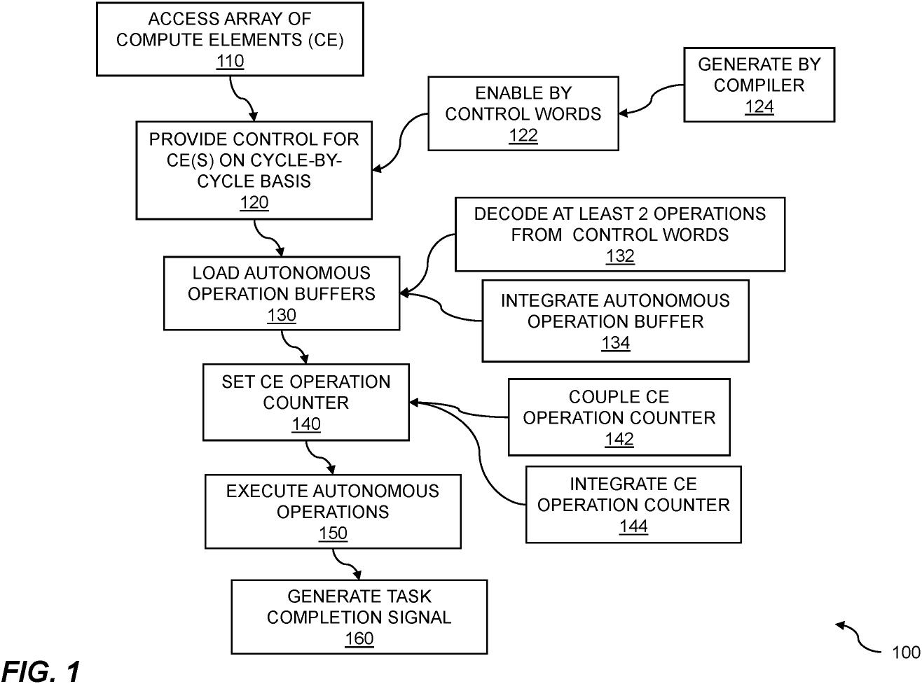

FIG. 1 is a flow diagram for autonomous compute element operation using buffers. Groupings of compute elements (CEs), such as CEs assembled within a 2D array of CEs, can be configured to execute a variety of operations associated with data processing. The operations can be based on tasks and on subtasks, where the subtasks are associated with the tasks. The 2D array can further interface with other elements such as controllers, storage elements, ALUs, memory management units (MMUs), GPUs, multiplier elements, and so on. The operations can accomplish a variety of processing objectives such as application processing, data manipulation, data analysis, modeling and simulation, and so on. The operations can manipulate a variety of data types including integer, real, and character data types; vectors, matrices, and arrays; tensors; etc. Control is provided to the array of compute elements on a cycle-by-cycle basis, where the control is enabled by a stream of wide control words generated by a compiler. The control words, which can include microcode control words, enable or idle various compute elements; provide data; route results between or among CEs, caches, scratchpads, and storage; and the like. The control enables compute element operation, memory access precedence, etc. Compute element operation and memory access precedence enable the hardware to properly sequence data provisioning and compute element results. The control enables execution of a compiled program on the array of compute elements.

The flow 100 includes accessing a two-dimensional (2D) array 110 of compute elements, wherein each compute element within the array of compute elements is known to a compiler and is coupled to its neighboring compute elements within the array of compute elements. The compute elements can be based on a variety of types of processors. The compute elements or CEs can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can include heterogeneous compute resources, where the heterogeneous compute resources may or may not be colocated within a single integrated circuit or chip. The compute elements can be configured in a topology, where the topology can be built into the array, programmed or dynamically configured within the array, etc. In embodiments, the array of compute elements is configured by a control word that can implement a topology. The topology that can be implemented can include one or more of a systolic, a vector, a cyclic, a spatial, a streaming, or a Very Long Instruction Word (VLIW) topology.

Further embodiments can include grouping a subset of compute elements within the array of compute elements. The subset of compute elements can comprise a cluster, a collection, a group, and so on. In embodiments, the subset can include compute elements that are adjacent to at least two other compute elements within the array of compute elements. The adjacent compute elements can share array resources such as control storage, scratchpad storage, communications paths, and the like. The compute elements can further include a topology suited to machine learning functionality, where the machine learning functionality is mapped by the compiler. A topology for machine learning can include supervised learning, unsupervised learning, reinforcement learning, and other machine learning topologies. The compute elements can be coupled to other elements within the array of CEs. In embodiments, the coupling of the compute elements can enable one or more further topologies. The other elements to which the CEs can be coupled can include storage elements such as one or more levels of cache storage, control units, multiplier units, address generator units for generating load (LD) and store (ST) addresses, queues, register files, and so on. The compiler to which each compute element is known can include a C, C++, or Python compiler. The compiler to which each compute element is known can include a compiler written especially for the array of compute elements. The coupling of each CE to its neighboring CEs enables clustering of compute resources; sharing of elements such as cache elements, multiplier elements, ALU elements, or control elements; communication between or among neighboring CEs; and the like.

The flow 100 includes providing control 120 to the array of compute elements on a cycle-by-cycle basis. The controlling the array can include configuration of elements such as compute elements within the array; loading and storing data; routing data to, from, and among compute elements; and so on. A cycle can include a clock cycle, an architectural cycle, a system cycle, a self-timed cycle, and the like. In the flow 100, the control is enabled 122 by a stream of wide, variable length, control words. The control words can include microcode control words, compressed control words, encoded control words, and the like. The control words can be decompressed, used, etc., to configure the compute elements and other elements within the array; to enable or disable individual compute elements, rows and/or columns of compute elements; to load and store data; to route data to, from, and among compute elements; and so on. The one or more control words are generated 124 by the compiler. The compiler which generates the control words can include a general-purpose compiler such as a C, C++, or Python compiler; a hardware description language compiler such as a VHDL or Verilog compiler; a compiler written for the array of compute elements; and the like. In embodiments, the stream of wide control words generated by the compiler provides direct fine-grained control of the 2D array of compute elements.

The compiler can be used to map functionality to the array of compute elements. In embodiments, the compiler can map machine learning functionality to the array of compute elements. The machine learning can be based on a machine learning (ML) network, a deep learning (DL) network, a support vector machine (SVM), etc. In embodiments, the machine learning functionality can include a neural network (NN) implementation. The neural network implementation can include a plurality of layers, where the layers can include one or more of input layers, hidden layers, output layers, and the like. A control word generated by the compiler can be used to configure one or more CEs, to enable data to flow to or from the CE, to configure the CE to perform an operation, and so on. Depending on the type and size of a task that is compiled to control the array of compute elements, one or more of the CEs can be controlled, while other CEs are unneeded by the particular task. A CE that is unneeded can be marked in the control word as unneeded. An unneeded CE requires no data and no control word. In embodiments, the unneeded compute element can be controlled by a single bit. In other embodiments, a single bit can control an entire row of CEs by instructing hardware to generate idle signals for each CE in the row. The single bit can be set for “unneeded”, reset for “needed”, or set for a similar usage of the bit to indicate when a particular CE is unneeded by a task. The control words are generated by the compiler. The control words that are generated by the compiler can include a conditionality such as a branch. The branch can include a conditional branch, an unconditional branch, etc. The control words that are compressed can be decompressed by a decompressor logic block that decompresses words from a compressed control word cache on their way to the array. In embodiments, the provided control can include a spatial allocation of subtasks on one or more compute elements within the array of compute elements. In other embodiments, the set of provided control can enable multiple, simultaneous programming loop instances circulating within the array of compute elements. The multiple programming loop instances can include multiple instances of the same programming loop, multiple programming loops, etc.

The flow 100 includes loading an autonomous operation buffer 130. Note that a control word that is generated by a compiler can include a number of operations. One or more operations can be contained in one or more control words. Multiple control words can be decoded. In embodiments, the control words can include control word bunches. The control word bunches can be associated with one or more subtasks, with one or more tasks, and so on. In embodiments, the control word bunches provide operational control of a particular compute element. The operational control can extend beyond a single control cycle. The operational control can specify a variety of operations such as arithmetic, logical, matrix, array, and tensor operations. In embodiments, the operational control specifies arithmetic logic unit (ALU) connections. In order for ALU connections to be accomplished, data indicating which operations can be performed must be provided. In embodiments, the operational control can specify compute element memory addresses and/or control. The memory address can be used to access storage such as one or more of register files, scratchpad memories, cache memories, shared memories, etc.

Further embodiments include loading additional autonomous operation buffers with additional operations contained in the one or more control words. The additional autonomous operation buffers can be associated with additional compute elements within a subset of compute elements. In the flow 100, at least two operations 132 are contained in one or more control words. While a subtask, for example, can include a single operation contained in a control word, a subtask or particularly a task will more often include multiple control words, each of which includes one or more operations. Two or more operations contained in the one or more control words can be loaded into buffers called autonomous operation buffers. Each autonomous operation buffer can be associated with compute element. In the flow 100, the autonomous operation buffer is integrated 134 in a compute element. Additional autonomous operation buffers can be coupled to additional compute elements (discussed below). In embodiments, each of the autonomous operation buffers can include a memory element with two read ports and one write port (2R1W). A 2R1W memory element can enable two read operations and one write operation to be executed substantially simultaneously. In other embodiments, the 2R1W memory element can include a “standalone” element within the 2-D array of elements, a compute element configured to act as a 2R1W memory element, and the like. In embodiments, a plurality of 2R1W physical register files can be distributed throughout the array of compute elements. The compute elements can be spatially separated, clustered, and the like. In embodiments, the autonomous operation buffer contains sixteen operational entries. Other numbers of operational entries can be stored, such as 2, 4, 8, 32, etc. operational entities. In embodiments, the operational entries can include compute element operations, compute element data paths, compute element ALU control, and compute element memory control. The number of operational entries that can be loaded into autonomous operation buffers can be controlled by the compiler. Discussed previously and throughout, the autonomous operation buffers can store compute element operations that are contained in control words generated by the compiler. The compute element operations configure compute elements, control compute element functionality, enable loading and storing of data, and the like.

The flow 100 includes setting 140 a compute element operation counter. The counter can include a set/reset counter, a count up/count down counter, and so on. The counter can be set with a value, a threshold, an iteration count, and the like. In the flow 100, the compute element operation counter is coupled 142 to the autonomous operation buffer. The coupling can be accomplished using a direct connection between the compute element and the compute element operation counter by accessing an interconnect which is available to components within the compute element, for example. In the flow 100, the counter is integrated 144 in the compute element. By integrating the counter in the compute element, control of the counter can be greatly simplified. Further embodiments include setting additional compute element operation counters, each coupled to an autonomous operation buffer of the additional operation buffers. The additional operation buffers can be associated with additional compute elements within a subset of compute elements within the 2D array of compute elements.

The flow 100 includes executing 150 the at least two operations, using the autonomous operation buffer and the compute element operation counter, wherein the operations complete autonomously from direct compiler control. The compute element operation counter can act effectively as a local “program counter”. The operation counter can be used to keep track of which operation is currently executing, the next operation to execute, and so on. The operations that are executed can be contained in a control word in a stream of control words. In embodiments, a control word in the stream of control words can include a data dependent branch operation. A data dependent branch operation can be based on a logical expression, an arithmetic operation, etc. A branch condition signal could also be imported from a neighboring compute element that is operating autonomously from the control unit, but cooperatively in a compute element grouping, as will be described later. Since a data dependent branch can cause the order of execution of operations to change, a latency can occur if new operations or different data must be obtained, which may be avoidable when operating autonomously out of a bunch buffer. In embodiments, the compiler can calculate a latency for the data dependent branch operation. The compiler can include operations to prefetch instructions, prefetch data if available, etc. In embodiments, the latency can be scheduled into compute element operations. Additional operations can be executed. Further embodiments include executing the additional operations loaded into the additional autonomous operation buffers cooperatively among the subset of compute elements. The cooperative operation can enable a topology such as machine learning. In embodiments, the additional operations complete autonomously from direct compiler control. Further, additional operations can complete based on the values within the compute element operation counters. The flow 100 further includes generating 160 a task completion signal. The task completion signal can include a flag, a semaphore, a message, a value, a character, and the like. In embodiments, the task completion signal can be based on a value in the compute element operation counter. In embodiments, the task completion signal can be based on a decision calculation within a compute element. The decision calculation can include an arithmetic calculation, a Boolean calculation, and so on. In embodiments, the compute element operation counter can track the cycling through of the autonomous operation buffer. Discussed throughout, the cycling can be associated with iteration, executing one or more operations on multiple blocks or sets of data, etc.

Discussed above and throughout, the operations that are executed can be associated with a task, a subtask, and so on. The operations can include arithmetic, logic, array, matrix, tensor, and other operations. A number of iterations of executing operations can be accomplished based on the contents of the operation counter within a given compute element. The particular operation or operations that are executed in a given cycle can be determined by the set of control word operations within the buffer. Recall that a control word bunch can provide operational control of a particular compute element. The compute element can be enabled for operation execution, idled for a number of cycles when the compute element is not needed, etc. Recall that the operations that are executed can be repeated. In embodiments, each set of operations associated with one or more control words can enable operational control of a particular compute element for a discrete cycle of operations. An operation can be based on the plurality of control bunches (i.e., sequences of operations) for a given compute element using its autonomous operation buffer(s). The operation that is being executed can include data dependent operations. In embodiments, the plurality of control words includes two or more data dependent branch operations. The branch operation can include two or more branches where a branch is selected based on an operation such as an arithmetic or logical operation. In a usage example, a branch operation can determine the outcome of an expression such as A > B. If A is greater than B, then one branch can be taken. If A is less than or equal to B, then another branch can be taken. In order to speed execution of a branch operation, sides of the branch can be precomputed prior to datum A and datum B being available. When the data are available, the expression can be computed, and the proper branch direction can be chosen. The untaken branch data and operations can be discarded, flushed, etc. In embodiments, the two or more data dependent branch operations can require a balanced number of execution cycles. The balanced number of execution cycles can reduce or eliminate idle cycles, stalling, and the like. In embodiments, the balanced number of execution cycles is determined by the compiler. In embodiments, the accessing, the providing, the loading, and the executing enable background memory accesses. The background memory access enables a control element to access memory independently of other compute elements, a controller, etc. In embodiments, the background memory accesses can reduce load latency. Load latency is reduced since a compute element can access memory before the compute element exhausts the data that the compute element is processing.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

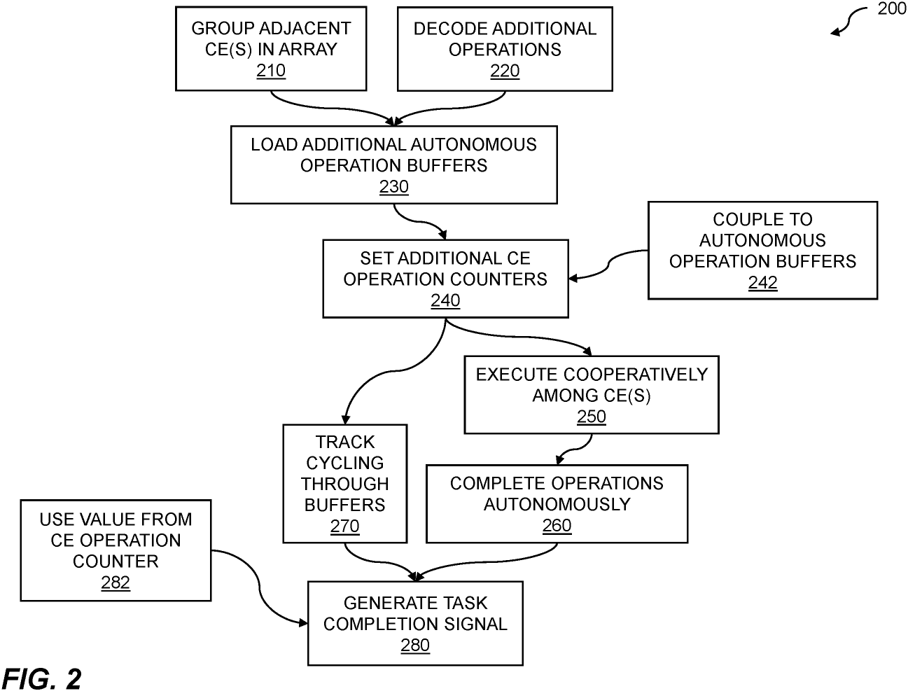

FIG. 2 is a flow diagram for buffer control and completion signal generation. One or more buffers, such as autonomous operation buffers, can be used to control one or more elements such as compute elements within an array of elements. Collections, clusters, or groupings of compute elements (CEs), such as CEs assembled within a 2D array of CEs, can be configured using control word bunches to execute a variety of operations associated with programs, codes, apps, and so on. The operations can be based on tasks, and on subtasks that are associated with the tasks. The 2D array can further interface with other elements such as controllers, storage elements, ALUs, MMUs, GPUs, multiplier elements, convolvers, neural networks, and the like. The operations can accomplish a variety of processing objectives such as application processing, data manipulation, design, emulation, simulation, and so on. The operations can perform manipulations of a variety of data types including integer, real, floating point, and character data types; vectors and matrices; tensors; etc. Control is provided to the array of compute elements on a cycle-by-cycle basis, where the control is based on control words generated by a compiler. The control words, which can include microcode control words, enable or idle various compute elements; provide data; route results between or among CEs, caches, and storage; and the like. The control can be based on a stream of control words, where the stream of control words comprises wide, variable length, control words generated by the compiler. Operations contained in one or more control words can be loaded into one or more autonomous operation buffers, where the autonomous operation buffers are integrated in one or more compute elements. The control, which is based on the control word bunches, enables compute element operation, memory access precedence, etc. The control word bunches provide operational control of a particular compute element. Compute element operation and memory access precedence enable the hardware to properly sequence compute element results.

Sets of control word bunches can be stored in bunch buffers. By using the control word bunches, a controller configures array elements such as compute elements, and enables execution of a compiled program based on tasks on the array. The compute elements can access registers, scratchpads, caches, and so on, that contain compressed and decompressed control words, data, etc. The control based on control word bunches enables autonomous compute element operation using buffers. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide control words generated by the compiler. An autonomous operation buffer is loaded with at least two operations contained in one or more control words. A single control word may include autonomous operation buffer operations for more than one compute element, however, multiple autonomous operation buffer operations for a single compute element will be supplied by multiple control words. The autonomous operation buffer is integrated in a compute element. A compute element operation counter, coupled to the autonomous operation buffer, is set, wherein the counter is integrated in the compute element. The at least two operations are executed using the autonomous operation buffer and the compute element operation counter, wherein the operations are completed autonomously from direct compiler control.

The compute elements can further include one or more topologies, where a topology can be mapped by the compiler. The topology mapped by the compiler can include a graph such as a directed graph (DG) or directed acyclic graph (DAG), a Petri Net (PN), etc. In embodiments, the compiler maps machine learning functionality to the array of compute elements. The machine learning can be based on supervised, unsupervised, and semi-supervised learning; deep learning (DL); and the like. In embodiments, the machine learning functionality can include a neural network implementation. The compute elements can be coupled to other elements within the array of CEs. In embodiments, the coupling of the compute elements can enable one or more topologies. The other elements to which the CEs can be coupled can include storage elements such as one or more levels of cache storage, multiplier units, address generator units for generating load (LD) and store (ST) addresses, queues, and so on. The compiler to which each compute element is known can include a C, C++, or Python compiler. The compiler to which each compute element is known can include a compiler written especially for the array of compute elements. The coupling of each CE to its neighboring CEs enables sharing of elements such as cache elements, multiplier elements, ALU elements, or control elements; communication between or among neighboring CEs; and the like.

The flow 200 includes grouping a subset of adjacent compute elements (CEs) 210 within the array of compute elements. The grouping of CEs can be based on a cluster of compute elements, where the cluster of CEs can share additional array elements such as storage elements, communication elements, and so on. In embodiments, the subset can include compute elements that are adjacent to at least two other compute elements within the array of compute elements. The adjacency of the compute elements can enable efficient operation execution. The flow 200 includes decoding additional operations 220 from the control word. Recall that a control word, which can include a control word bunch, can control one or more CEs within a 2D array of CEs. The CEs controlled by the control word can include a row of CEs within the array, a column of CEs within the array, a cluster of CEs, a subset of CEs, and so on. A control word is decoded in order to determine one or more CE operations. The flow 200 further includes loading additional autonomous operation buffers 230 with additional operations contained in the one or more control words.

The flow 200 further includes setting additional compute element operation counters 240. The count to which the counters can be set can be based on a number of operations, a number of times operations can be repeated, and so on. In the flow 200, each of the additional compute element operation counters is coupled 242 to an autonomous operation buffer of the additional operation buffers. In embodiments, additional compute element operation counters are integrated in compute elements with which the counters are associated. The flow 200 further includes executing the additional operations 250 cooperatively among the subset of compute elements. The executing can be based on the additional compute element operations, shared operations, and so on. The cooperative execution of CE operations can include autonomous operation of the CEs. That is, the CEs do not require further loading of compiler commands, but can operate among themselves, and, upon completion, signal a central control unit to resume control word execution and fetch. In the flow 200, the additional operations complete autonomously 260 from compiler control, that is, the compiler doesn’t directly control operational completion beyond initially setting up the operation(s). The autonomous completion of the additional operations can be based on a count within the additional CE operation counters. The autonomous CE and CE array execution out of bunch buffers can enable the control word fetch pipeline to fill and be “ready” to resume and run without and potential control word fetch and decompress pipeline delays.

In the flow 200, the compute element operation counter tracks cycling 270 through the autonomous operation buffer. The tracking of cycling can be based on a compiler loop instruction. The tracking cycling can enable executing a loop, iteration, repeating execution of operations on multiple datasets (e.g., single instruction multiple data (SIMD) execution), and the like. The flow 200 further includes generating 280 a task completion signal. The task completion signal can include a flag, a semaphore, a message, and so on, that can be communicated to a controller associated with the compute elements executing operations. In the flow 200, the task completion signal is based on a value 282 in the compute element operation counter. The task completion can be determined by the counter counting up to the value, down to the value, and so on. In a usage example, the task completion signal can be based on the compute element operation counter counting down to zero. The generating the task completion signal can be based on evaluating an expression, function, and so on.

The setting the one or more compute element operation counters can enable operation looping within the compute elements. Iteration looping can be accomplished by overflow or underflow of the CE operation counter, by a preloaded value, and the like. In embodiments, the operation looping can be enabled without additional control word loading. The operation looping can accomplish a variety of task and subtask execution techniques. In embodiments, the operation looping can accomplish dataflow processing within statically scheduled compute elements. The dataflow processing is based on executing a task, subtask, and so on, when needed data is available for processing, and idling when the needed data is not available. Dataflow processing is a technique that can be used to process data without the need for a control signal such as a local clock, a module clock, a system clock, etc.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

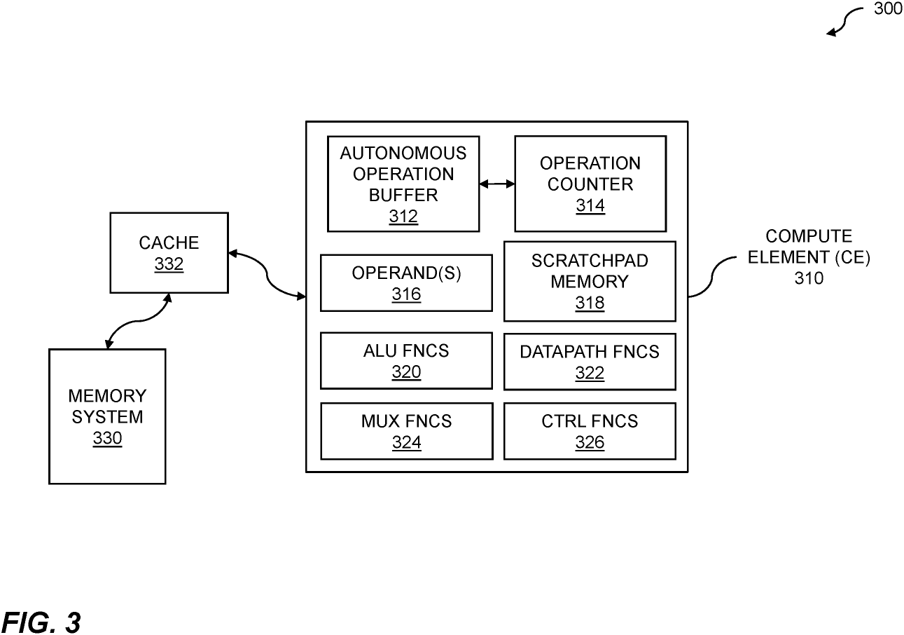

FIG. 3 is a system block diagram for a compute element. The compute element can represent a compute element within an array such as a two-dimensional array of compute elements. The array of compute elements can be configured to perform a variety of operations such as arithmetic, logical, matrix, and tensor operations. The array of compute elements can be configured to perform higher level processing operations, such as video processing and audio processing operations. The array can be further configured for machine learning functionality, where the machine learning functionality can include a neural network implementation. One or more compute elements can be configured for autonomous compute element operation using buffers. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide control words generated by the compiler. An autonomous operation buffer is loaded with at least two operations contained in one or more control words, wherein the autonomous operation buffer is integrated in a compute element. A compute element operation counter, coupled to the autonomous operation buffer, is set, wherein the compute element operation counter is integrated in the compute element. The at least two operations are executed, using the autonomous operation buffer and the compute element operation counter, wherein the operations complete autonomously from direct compiler control.

The system block diagram 300 can include a compute element (CE) 310. The compute element can be configured by providing control in the form of control words, where the control words are generated by a compiler. The compiler can include a high-level language compiler, a hardware description language compiler, and so on. The compute element can include one or more components, where the components can enable or enhance operations executed by the compute element. The system block diagram 300 can include an autonomous operation buffer 312. The autonomous operation buffer can include at least two operations contained in one or more control words. The at least two operations can result from compilation by the compiler of code to perform a task, a subtask, a process, and so on. The at least two operations can be obtained from memory, loaded when the 2-D array of compute elements is scheduled, and the like. The operations can include one or more fields, where the fields can include an instruction field, one or more or more operands, and so on. In embodiments, the system block diagram can further include additional autonomous operation buffers. The additional operation buffers can include at least two operations. The operations can be substantially similar to the operations loaded in the autonomous operation buffer or can be substantially different from the operations loaded in the autonomous operation buffer. In embodiments, the autonomous operation buffer contains sixteen operational entries.

The system block diagram can include an operation counter 314. The operation counter can act as a counter, such as a program counter, to keep track of which operation with the autonomous operation buffer is the current operation. In embodiments, the compute element operation counter can track the cycling through of the autonomous operation buffer. Cycling through of the autonomous operation buffer can accomplish iteration, repeated operations, and so on. In embodiments, additional operation counters can be associated with the additional autonomous operation buffers. In embodiments, an operation in the autonomous operation buffer or in one or more of the additional autonomous operation buffers can comprise one or more operands 316, one or more data addresses for a memory such as a scratchpad memory, and the like. The block diagram 300 can include a scratchpad memory 318. The operand can be used to perform an operation on the contents of the scratchpad memory. Discussed below, the contents of the scratchpad memory can be obtained from a cache (332), local storage, remote storage, and the like. The scratchpad memory elements can include register files, which can include one or more 2R1W register files. The one or more 2R1W register files can be located within one compute element. The compute element can further include components for performing various functions. The block diagram 300 can include arithmetic logic unit (ALU) functions 320, which can include logical functions. The arithmetic functions can include multiplication, division, addition, subtraction, maximum, minimum, average, etc. The logical functions can include AND, OR, NAND, NOR, XOR, XNOR, NOT, SHIFT, and other logical operations. In embodiments, the logical functions and the mathematical functions can be accomplished using a component such as an arithmetic logic unit (ALU).

A compute element such as compute element 310 can communicate with one or more additional compute elements. The compute elements can be colocated within a 2D array of compute elements as the compute element, or can be located in other arrays. The compute element can further be in communication with additional elements and components such as with local storage, with remote storage, and so on. The block diagram 300 can include datapath functions 322. The datapath functions can control the flow of data through a compute element, the flow of data between the compute element and other components, and so. The datapath functions can control communications between and among compute elements within the 2D array. The communications can be accomplished using a bus such as an industry standard bus, a ring bus, a network such as a wired or wireless computer network, etc. The block diagram 300 can include multiplexer MUX functions 324. The multiplexer, which can include a distributed MUX, can be controlled by the MUX functions. In embodiments, the ring bus can be implemented as a distributed MUX. The block diagram 300 can include control functions 326. The control functions can be used to configure or schedule one or more compute elements within the 2D array of compute elements. The control functions can enable one or more compute elements, disable one or more compute elements, and so on. A compute element can be enabled or disabled based on whether the compute element is needed for an operation within a given control cycle.

The contents of registers, operands, requested data, and so on, can be obtained from various types of storage. In the block diagram 300, the contents can be obtained from a memory system 330. The memory system can be shared among compute elements within the 2D array of compute elements. The memory system can be included within the 2D array of compute elements, coupled to the array, located remotely from the array, etc. The memory system can include a high-speed memory system. Contents of the memory system, such as requested data, can be loaded into one or more caches 332. The one or more caches can be coupled to a compute element, a plurality of compute elements, and so on. The caches can include multilevel caches (discussed below), such as L1, L2, and L3 caches. Other memory or storage can be coupled to the compute element.

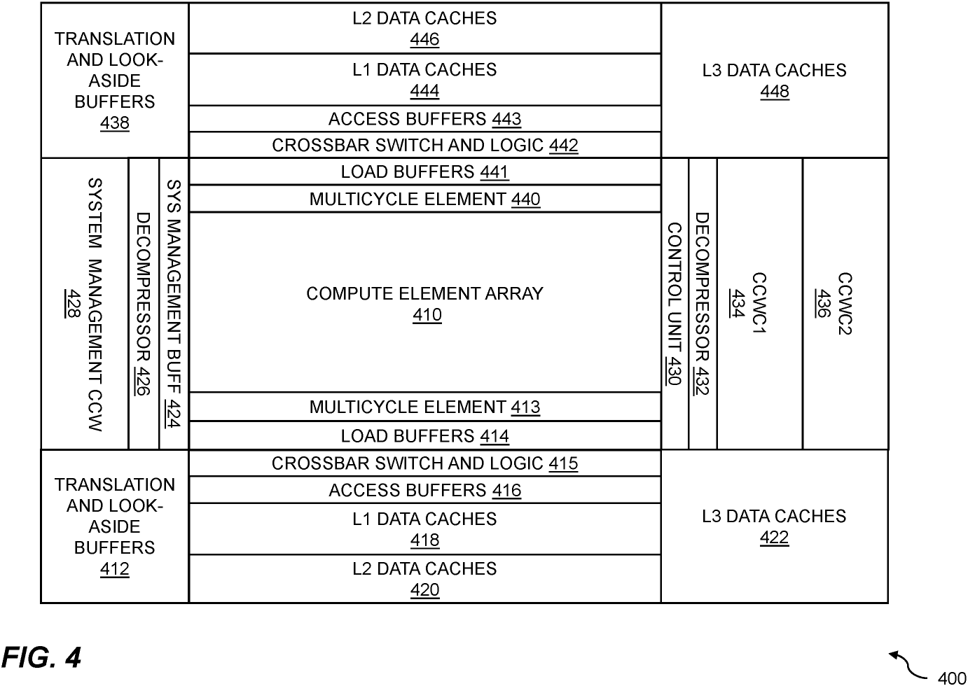

FIG. 4 illustrates a system block diagram for a highly parallel architecture with a shallow pipeline. The highly parallel architecture can comprise components including compute elements, processing elements, buffers, one or more levels of cache storage, system management, arithmetic logic units, multipliers, and so on. The various components can be used to accomplish task processing, where the task processing is associated with program execution, job processing, etc. The task processing is enabled based on autonomous compute element operation using buffers. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide control words generated by the compiler. An autonomous operation buffer is loaded with at least two operations contained in one or more control words, wherein the autonomous operation buffer is integrated in a compute element. A compute element operation counter, coupled to the autonomous operation buffer, is set, wherein the compute element operation counter is integrated in the compute element. The at least two operations are executed, using the autonomous operation buffer and the compute element operation counter, wherein the operations complete autonomously from direct compiler control.

A system block diagram 400 for a highly parallel architecture with a shallow pipeline is shown. The system block diagram can include a compute element array 410. The compute element array 410 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 400 can include translation and look-aside buffers such as translation and look-aside buffers 412 and 438. The translation and look-aside buffers can comprise memory caches, where the memory caches can be used to reduce storage access times.

The system block diagram 400 can include logic for load and store access order and selection. The logic for load and store access order and selection can include crossbar switch and logic 415 along with crossbar switch and logic 442. Crossbar switch and logic 415 can accomplish load and store access order and selection for the lower data cache blocks (418 and 420), and crossbar switch and logic 442 can accomplish load and store access order and selection for the upper data cache blocks (444 and 446). Crossbar switch and logic 415 enables high-speed data communication between the lower-half compute elements of compute element array 410 and data caches 418 and 420 using access buffers 416. Crossbar switch and logic 442 enables high-speed data communication between the upper-half compute elements of compute element array 410 and data caches 444 and 446 using access buffers 443. The access buffers 416 and 443 allow logic 415 and logic 442, respectively, to hold, load, or store data until any memory hazards are resolved. In addition, splitting the data cache between physically adjacent regions of the compute element array can enable the doubling of load access bandwidth, the reducing of interconnect complexity, and so on. While loads can be split, stores can be driven to both lower data caches 418 and 420 and upper data caches 444 and 446.

The system block diagram 400 can include lower load buffers 414 and upper load buffers 441. The load buffers can provide temporary storage for memory load data so that it is ready for low latency access by the compute element array 410. The system block diagram can include dual level 1 (L1) data caches, such as L1 data caches 418 and 444. The L1 data caches can be used to hold blocks of load and/or store data, such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 420 and 446. The L2 caches can include larger, slower storage in comparison to the L1 caches. The L2 caches can store “next up” data, results such as intermediate results, and so on. The L1 and L2 caches can further be coupled to level 3 (L3) caches. The L3 caches can include L3 caches 422 and 448. The L3 caches can be larger than the L2 and L1 caches and can include slower storage. Accessing data from L3 caches is still faster than accessing main storage. In embodiments, the L1, L2, and L3 caches can include 4-way set associative caches.

The system block diagram 400 can include lower multicycle element 413 and upper multicycle element 440. The multicycle elements (MEMs) can provide efficient functionality for operations that span multiple cycles, such as multiplication operations, or even be of indeterminant cycle length, such as some divide and square root operations. The MEMs can operate on data coming out of the compute element array and/or data moving into the compute element array. Multicycle element 413 can be coupled to the compute element array 410 and load buffers 414, and multicycle element 440 can be coupled to compute element array 410 and load buffers 441.

The system block diagram 400 can include a system management buffer 424. The system management buffer can be used to store system management codes or control words that can be used to control the array 410 of compute elements. The system management buffer can be employed for holding opcodes, codes, routines, functions, etc. which can be used for exception or error handling, management of the parallel architecture for processing tasks, and so on. The system management buffer can be coupled to a decompressor 426. The decompressor can be used to decompress system management compressed control words (CCWs) from system management compressed control word buffer 428 and can store the decompressed system management control words in the system management buffer 424. The compressed system management control words can require less storage than the uncompressed control words. The system management CCW component 428 can also include a spill buffer. The spill buffer can comprise a large static random-access memory (SRAM), which can be used to provide rapid support of multiple nested levels of exceptions.

The compute elements within the array of compute elements can be controlled by a control unit such as control unit 430. While the compiler, through the control word, controls the individual elements, the control unit can pause the array to ensure that new control words are not driven into the array. The control unit can receive a decompressed control word from a decompressor 432 and can drive out the decompressed control word into the appropriate compute elements of compute element array 410. The decompressor can decompress a control word (discussed below) to enable or idle rows or columns of compute elements, to enable or idle individual compute elements, to transmit control words to individual compute elements, etc. The decompressor can be coupled to a compressed control word store such as compressed control word cache 1 (CCWC1) 434. CCWC1 can include a cache such as an L1 cache that includes one or more compressed control words. CCWC1 can be coupled to a further compressed control word store such as compressed control word cache 2 (CCWC2) 436. CCWC2 can be used as an L2 cache for compressed control words. CCWC2 can be larger and slower than CCWC1. In embodiments, CCWC1 and CCWC2 can include 4-way set associativity. In embodiments, the CCWC1 cache can contain decompressed control words, in which case it could be designated as DCWC1. In that case, decompressor 432 can be coupled between CCWC1 434 (now DCWC1) and CCWC2 436.

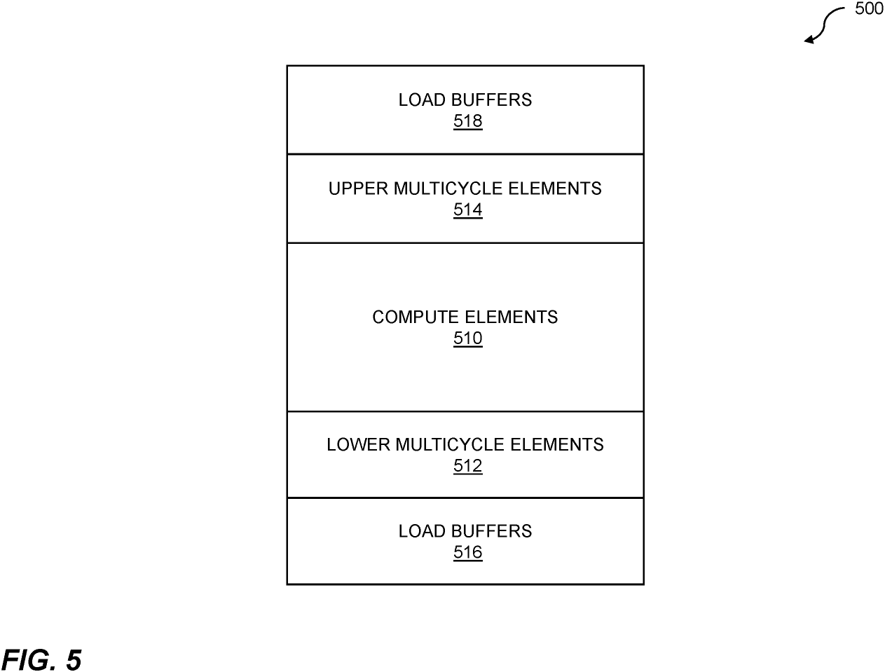

FIG. 5 shows compute element array detail 500. A compute element array can be coupled to components which enable the compute elements within the array to process one or more tasks, subtasks, and so on. The components can access and provide data, perform specific high-speed operations, and the like. The compute element array and its associated components enable autonomous compute element operation using buffers. The compute element array 510 can perform a variety of processing tasks, where the processing tasks can include operations such as arithmetic, vector, matrix, or tensor operations; audio and video processing operations; neural network operations; etc. The compute elements can be coupled to multicycle elements such as lower multicycle elements 512 and upper multicycle elements 514. The multicycle elements can be used to perform, for example, high-speed multiplications associated with general processing tasks, multiplications associated with neural networks such as deep learning networks, multiplications associated with vector operations, and the like. The compute elements can be coupled to load buffers such as load buffers 516 and load buffers 518. The load buffers can be coupled to the L1 data caches as discussed previously. In embodiments, a crossbar switch (not shown) can be coupled between the load buffers and the data caches. The load buffers can be used to load storage access requests from the compute elements. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, it is still considered active.

While the array of compute elements is paused, background loading of the array from the memories (data memory and control word memory) can be performed. The memory systems can be free running and can continue to operate while the array is paused. Because multicycle latency can occur due to control signal transport that results in additional “dead time”, allowing the memory system to “reach into” the array and to deliver load data to appropriate scratchpad memories can be beneficial while the array is paused. This mechanism can operate such that the array state is known, as far as the compiler is concerned. When array operation resumes after a pause, new load data will have arrived at a scratchpad, as required for the compiler to maintain the statically scheduled model.

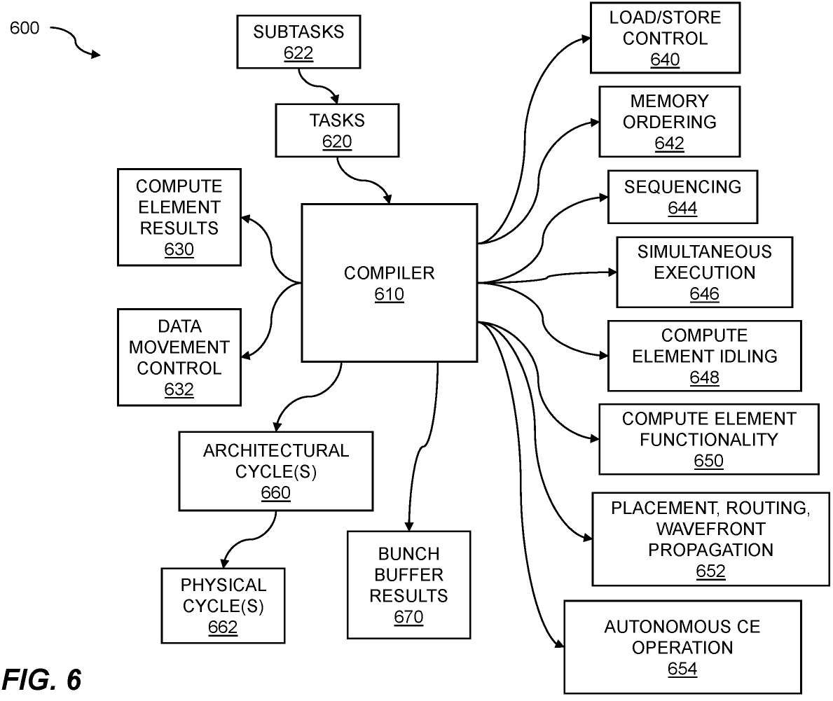

FIG. 6 illustrates a system block diagram for compiler interactions. Discussed throughout, compute elements within a 2D array are known to a compiler which can compile tasks and subtasks for execution on the array. The compiled tasks and subtasks are executed to accomplish task processing. A variety of interactions, such as configuration of compute elements, placement of tasks, routing of data, and so on, can be associated with the compiler. The compiler interactions enable autonomous compute element operation using buffers. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide control words generated by the compiler. An autonomous operation buffer is loaded with at least two operations contained in one or more control words, wherein the autonomous operation buffer is integrated in a compute element. A compute element operation counter, coupled to the autonomous operation buffer, is set, wherein the compute element operation counter is integrated in the compute element. The at least two operations are executed, using the autonomous operation buffer and the compute element operation counter, wherein the operations complete autonomously from direct compiler control.

The system block diagram 600 includes a compiler 610. The compiler can include a high-level compiler such as a C, C++, Python, or similar compiler. The compiler can include a compiler implemented for a hardware description language such as a VHDL® or Verilog® compiler. The compiler can include a compiler for a portable, language-independent, intermediate representation such as low-level virtual machine (LLVM) intermediate representation (IR). The compiler can generate a set of directions that can be provided to the compute elements and other elements within the array. The compiler can be used to compile tasks 620. The tasks can include a plurality of tasks associated with a processing task. The tasks can further include a plurality of subtasks 622. The tasks can be based on an application such as a video processing or audio processing application. In embodiments, the tasks can be associated with machine learning functionality. The compiler can generate directions for handling compute element results 630. The compute element results can include results derived from arithmetic, vector, array, and matrix operations; Boolean operations; and so on. In embodiments, the compute element results are generated in parallel in the array of compute elements. Parallel results can be generated by compute elements when the compute elements can share input data, use independent data, and the like. The compiler can generate a set of directions that controls data movement 632 for the array of compute elements. The control of data movement can include movement of data to, from, and among compute elements within the array of compute elements. The control of data movement can include loading and storing data, such as temporary data storage, during data movement. In other embodiments, the data movement can include intra-array data movement.

As with a general-purpose compiler used for generating tasks and subtasks for execution on one or more processors, the compiler can provide directions for task and subtasks handling, input data handling, intermediate and final result data handling, and so on. The compiler can further generate directions for configuring the compute elements, storage elements, control units, ALUs, and so on, associated with the array. As previously discussed, the compiler generates directions for data handling to support the task handling. In the system block diagram, the data movement can include control of data loads and stores 640 with a memory array. The loads and stores can include handling various data types such as integer, real or float, double-precision, character, and other data types. The loads and stores can load and store data into local storage such as registers, register files, caches, and the like. The caches can include one or more levels of cache such as a level 1 (L1) cache, level 2 (L2) cache, level 3 (L3) cache, and so on. The loads and stores can also be associated with storage such as shared memory, distributed memory, etc. In addition to the loads and stores, the compiler can handle other memory and storage management operations including memory precedence. In the system block diagram, the memory access precedence can enable ordering of memory data 642. Memory data can be ordered based on task data requirements, subtask data requirements, task priority or precedence, and so on. The memory data ordering can enable parallel execution of tasks and subtasks.

In the system block diagram 600, the ordering of memory data can enable compute element result sequencing 644. In order for task processing to be accomplished successfully, tasks and subtasks must be executed in an order that can accommodate task priority, task precedence, a schedule of operations, and so on. The memory data can be ordered such that the data required by the tasks and subtasks can be available for processing when the tasks and subtasks are scheduled to be executed. The results of the processing of the data by the tasks and subtasks can therefore be ordered to optimize task execution, to reduce or eliminate memory contention conflicts, etc. The system block diagram includes enabling simultaneous execution 646 of two or more potential compiled task outcomes based on the set of directions. The code that is compiled by the compiler can include branch points, where the branch points can include computations or flow control. Flow control transfers program execution to a different sequence of control words. Since the result of a branch decision, for example, is not known a priori, the initial operations associated with both paths are encoded in the currently executing control word stream. When the correct result of the branch is determined, then the sequence of control words associated with the correct branch result continues execution, while the operations for the branch path not taken are halted and side effects may be flushed. In embodiments, the two or more potential branch paths can be executed on spatially separate compute elements within the array of compute elements.

The system block diagram includes compute element idling 648. In embodiments, the set of directions from the compiler can idle an unneeded compute element within a row of compute elements located in the array of compute elements. Not all of the compute elements may be needed for processing, depending on the tasks, subtasks, and so on that are being processed. The compute elements may not be needed simply because there are fewer tasks to execute than there are compute elements available within the array. In embodiments, the idling can be controlled by a single bit in the control word generated by the compiler. In the system block diagram, compute elements within the array can be configured for various compute element functionalities 650. The compute element functionality can enable various types of compute architectures, processing configurations, and the like. In embodiments, the set of directions can enable machine learning functionality. The machine learning functionality can be trained to process various types of data such as image data, audio data, medical data, etc. In embodiments, the machine learning functionality can include neural network implementation. The neural network can include a convolutional neural network, a recurrent neural network, a deep learning network, and the like. The system block diagram can include compute element placement, results routing, and computation wave-front propagation 652 within the array of compute elements. The compiler can generate directions or instructions that can place tasks and subtasks on compute elements within the array. The placement can include placing tasks and subtasks based on data dependencies between or among the tasks or subtasks, placing tasks that avoid memory conflicts or communications conflicts, etc. The directions can also enable computation wave-front propagation. Computation wave-front propagation can implement and control how execution of tasks and subtasks proceeds through the array of compute elements. In the system block diagram 600, the compiler 610 can enable autonomous compute element (CE) operation 654. As discussed throughout, the autonomous operation is set up by one or more control words generated by the compiler that enable a CE to complete an operation autonomously, that is, not under direct compiler control.

In the system block diagram, the compiler can control architectural cycles 660. An architectural cycle can include an abstract cycle that is associated with the elements within the array of elements. The elements of the array can include compute elements, storage elements, control elements, ALUs, and so on. An architectural cycle can include an “abstract” cycle, where an abstract cycle can refer to a variety of architecture level operations such as a load cycle, an execute cycle, a write cycle, and so on. The architectural cycles can refer to macro-operations of the architecture rather than to low level operations. One or more architectural cycles are controlled by the compiler. Execution of an architectural cycle can be dependent on two or more conditions. Architectural cycles are under direct control of the compiler-as opposed to wall clock cycles, which can encompass the indeterminacies of memory operation. In embodiments, an architectural cycle can occur when a control word is available to be driven into the array of compute elements and when all data dependencies are met. That is, the array of compute elements does not have to wait for either dependent data to load or for a full memory queue to clear or drain. In the system block diagram, the architectural cycle can include one or more physical cycles 662. A physical cycle can refer to one or more cycles at the element level that are required to implement a load, an execute, a write, and so on. In embodiments, the set of directions can control the array of compute elements on a physical cycle-by-cycle basis. The physical cycles can be based on a clock such as a local, module, or system clock, or some other timing or synchronizing technique. In embodiments, the physical cycle-by-cycle basis can include an architectural cycle. The physical cycles can be based on an enable signal for each element of the array of elements, while the architectural cycle can be based on a global, architectural signal. In embodiments, the compiler can provide, via the control word, valid bits for each column of the array of compute elements, on the cycle-by-cycle basis. A valid bit can indicate that data is valid and ready for processing, that an address such as a jump address is valid, and the like. In embodiments, the valid bits can indicate that a valid memory load access is emerging from the array. The valid memory load access from the array can be used to access data within a memory or storage element. Similarly, a returning load can be tagged with a valid bit as part of a background load protocol to enable that data to be written into a compute element’s memory outside of direct compiler control. In other embodiments, the compiler can provide, via the control word, operand size information for each column of the array of compute elements. Various operand sizes can be used. In embodiments, the operand size can include bytes, half-words, words, and double-words.

Discussed above and throughout, the control word bits can include a control word bunch. A control word bunch comprises a subset of bits in a control word, that is groups of bits or subfields of bits, called bunches, which directly control individual CEs. In embodiments, the control word bunch can provide operational control of a particular compute element, a multiplier unit, and so on. Buffers, or “bunch buffers” can be placed at each control element. In embodiments, the bunch buffers can hold a number of bunches such as 16 bunches. Other numbers of bunches such as 8, 32, 64 bunches, and so on, can also be used. Thus, while control word bunches are related to the operations contained in the bunch buffers, they are not equivalent and should not be confused. In the system block diagram, the compiler can control what to do with bunch buffer results 670. The results of a bunch buffer can be stored in local scratchpad memory, can be stored in global memory, can control an associated compute element or multiplier element, can be used in another compute element, etc. In embodiments, an iteration counter can be associated with each bunch buffer. The interaction counter can be used to control a number of times that the bits within the bunch buffer are cycled through. In further embodiments, a bunch buffer pointer can be associated with each bunch buffer. The bunch buffer counter can be used to indicate or “point to” the next bunch of control word bits to apply to the compute element or multiplier element. In embodiments, data paths associated with the bunch buffers can be balanced during a compile time associated with processing tasks, subtasks, and so on. The balancing the data paths can enable compute elements to operate without the risk of a single compute element being starved for data, which could result in stalling the two-dimensional array of compute elements as data is obtained for the compute element. Further, the balancing the data paths can enable an autonomous operation technique. In embodiments, the autonomous operation technique can include a dataflow technique.

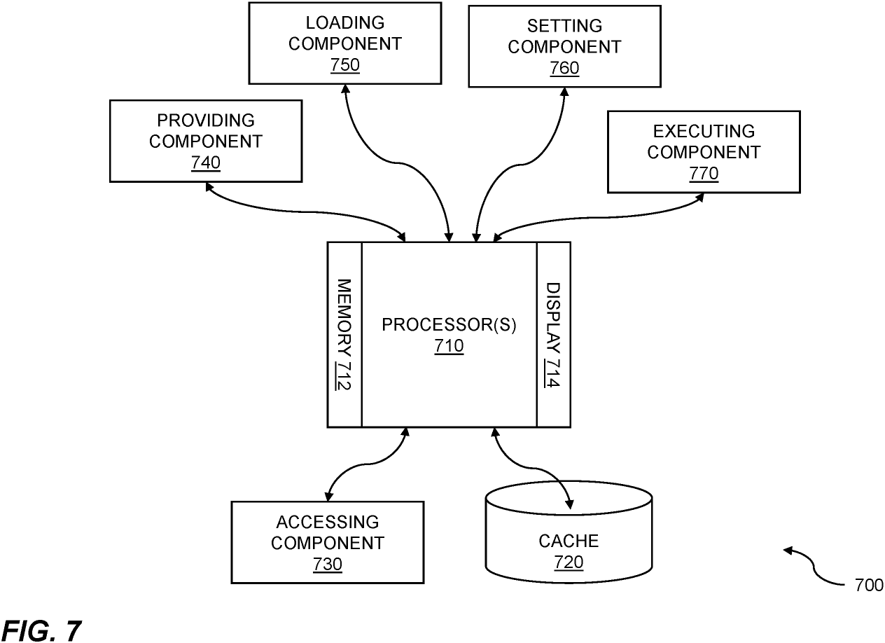

FIG. 7 is a system diagram for task processing. The task processing is enabled by autonomous compute element operation using buffers. The system 700 can include one or more processors 710, which are attached to a memory 712 which stores instructions. The system 700 can further include a display 714 coupled to the one or more processors 710 for displaying data; intermediate steps; directions; control words; control word bunches; compressed control words; control words implementing Very Long Instruction Word (VLIW) functionality; topologies including systolic, vector, cyclic, spatial, streaming, or VLIW topologies; and so on. In embodiments, one or more processors 710 are coupled to the memory 712, wherein the one or more processors, when executing the instructions which are stored, are configured to: access a two-dimensional (2D) array of compute elements, wherein each compute element within the array of compute elements is known to a compiler and is coupled to its neighboring compute elements within the array of compute elements; provide control for the array of compute elements on a cycle-by-cycle basis, wherein the control is enabled by a stream of wide control words generated by the compiler; load an autonomous operation buffer with at least two operations contained in one or more control words, wherein the autonomous operation buffer is integrated in a compute element; set a compute element operation counter, coupled to the autonomous operation buffer, wherein the compute element operation counter is integrated in the compute element; and execute the at least two operations, using the autonomous operation buffer and the compute element operation counter, wherein the operations complete autonomously from direct compiler control. The compute elements can include compute elements within one or more integrated circuits or chips; compute elements or cores configured within one or more programmable chips such as application specific integrated circuits (ASICs); field programmable gate arrays (FPGAs); heterogeneous processors configured as a mesh; standalone processors; etc.

The system 700 can include a cache 720. The cache 720 can be used to store data such as scratchpad data, operations that support a balanced number of execution cycles for a data-dependent branch; directions to compute elements, control words, and control word bunches comprising control word bits; intermediate results; microcode; branch decisions; and so on. The cache can comprise a small, local, easily accessible memory available to one or more compute elements. In embodiments, the data that is stored can include operations, additional operations, and so on, where the operations and additional operations are contained in one or more control words and can be loaded into one or more autonomous operation buffers. The operations, additional operations, and the like can enable autonomous compute element operations using buffers. The data within the cache can include data required to support dataflow processing by statically scheduled compute elements within the 2D array of compute elements. The cache can be accessed by one or more compute elements. The cache, if present, can include a dual read, single write (2R1W) cache. That is, the 2R1W cache can enable two read operations and one write operation contemporaneously without the read and write operations interfering with one another.

The system 700 can include an accessing component 730. The accessing component 730 can include control logic and functions for accessing a two-dimensional (2D) array of compute elements. Each compute element within the array of compute elements is known to a compiler and is coupled to its neighboring compute elements within the array of compute elements. A compute element can include one or more processors, processor cores, processor macros, processor cells, and so on. Each compute element can include an amount of local storage. The local storage may be accessible by one or more compute elements. Each compute element can communicate with neighbors, where the neighbors can include nearest neighbors or more remote “neighbors”. Communication between and among compute elements can be accomplished using a bus such as an industry standard bus, a ring bus, a network such as a wired or wireless computer network, etc. In embodiments, the ring bus is implemented as a distributed multiplexor (MUX).

The system 700 can include a providing component 740. The providing component 740 can include control and functions for providing control for the array of compute elements on a cycle-by-cycle basis, wherein the control is enabled by a stream of wide control words generated by the compiler. The control words can be based on low-level control words such as assembly language words, microcode words, and so on. The control word can include control word bunches. In embodiments, the control word bunches can provide operational control of a particular compute element. The control of the array of compute elements on a cycle-by-cycle basis can include configuring the array to perform various compute operations. In embodiments, the stream of wide control words generated by the compiler provides direct, fine-grained control of the 2D array of compute elements. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. A control can enable machine learning functionality for the neural network topology.

The system block diagram 700 can include a loading component 750. The loading component 750 can include control and functions for loading an autonomous operation buffer with at least two operations contained in one or more control words, wherein the autonomous operation buffer is integrated in a compute element. The operations control can specify operations such as load operations, store operations, and so on. In embodiments, the autonomous operation buffer can contain sixteen operational entries. The operation buffer can contain other numbers of operational entries such as two, four, eight, or thirty-two entries, etc. In embodiments, the operational entries can include compute element operations, compute element data paths, compute element ALU control, compute element memory control, and the like. In embodiments, the operational control can specify arithmetic logic unit (ALU) connections. The ALU connections can connect an ALU component to a compute element in order to perform arithmetic operations such as multiplication, division, addition, and subtraction; logical operations such as AND, NAND, OR, NOR, XOR XNOR, shift, and rotate; etc. In embodiments, the operational control can specify compute element memory addresses and/or control. The memory addresses and/or control can include memory addresses from which or to which data can be loaded or stored. The control can include enabling a load or store operation, ensuring that reading data from and writing data to a given memory address occurs in the correct order, etc. Embodiments further include loading additional autonomous operation buffers with additional operations contained in the one or more control words. The additional operations can be loaded for additional compute elements among a subset of compute elements.

The system 700 can include a setting component 760. The setting component 760 can include control and functions for setting a compute element operation counter, coupled to the autonomous operation buffer, wherein the compute element operation counter is integrated in the compute element. The operation counter can be used to count through the at least two operations, to repeat the at least two operations, and so on. In embodiments, the compute element operation counter can track cycling through the autonomous operation buffer. The cycling through the autonomous operation buffer can enable repeated execution of compute element operations (discussed shortly below). The cycling through the autonomous operation buffer can be based on data availability (e.g., a dataflow technique). Further embodiments can include setting additional compute element operation counters, each coupled to an autonomous operation buffer of the additional operation buffers. The additional operations can be associated with one or more additional compute elements. The additional compute elements can include additional compute elements within the subset of compute elements.

The system 700 can include an executing component 770. The executing component 770 can include control and functions for executing the at least two operations, using the autonomous operation buffer and the compute element operation counter, wherein the operations complete autonomously from direct compiler control. The operations that can be performed can include arithmetic operations, Boolean operations, matrix operations, neural network operations, and the like. The operations can be executed based on the control words generated by the compiler. The control words can be provided to a control unit, where the control unit can control the operations of the compute elements within the array of compute elements. Operation of the compute elements can include configuring the compute elements, providing data to the compute elements, routing and ordering results from the compute elements, and so on. Embodiments further include generating a task completion signal. The task completion signal can include a flag, a semaphore, a message, and so on. In embodiments, the task completion signal can be based on a value in the compute element operation counter. The additional operations can also be executed. Embodiments further include executing the additional operations cooperatively among the subset of compute elements. The additional operations can include parallel operations. In embodiments, the additional operations can complete autonomously from direct compiler control. The autonomous completion of the additional operations can reduce a number of compiler instructions, free the compiler from having to keep track of detailed memory access timing issues, and so on.

The same control operations associated with control words can be executed on a given cycle across the array of compute elements. The operations can provide control on a per compute element basis, where each control word can be comprised of a plurality of compute element control groups, clusters, and so on. In embodiments, a control unit can operate on compute element operations. The executing operations can include distributed execution of operations. In embodiments, the distributed execution of operations can occur in two or more compute elements within the array of compute elements. The executing operations can include storage access, where the storage can include a scratchpad memory, one or more caches, register files, etc., within the 2D array of compute elements. Further embodiments include a memory operation outside of the array of compute elements. The “outside” memory operation can include access to a memory such as a high-speed memory, a shared memory, a remote memory, etc. In embodiments, the memory operation can be enabled by autonomous compute element operation. As for other control associated with the array of compute elements, the autonomous compute element operation is controlled by the operations and the additional operations. In a usage example, operations and additional operations can be loaded into buffers to control operation of one or more compute elements. Data to be operated on by the compute element operations can be loaded. Data operations can be performed by the compute elements without loading further control word bunches for a number of cycles. The autonomous compute element operation can be based on operation looping. In embodiments, the operation looping can accomplish dataflow processing within statically scheduled compute elements. Dataflow processing can include processing based on the presence or absence of data. The dataflow processing can be performed without requiring access to external storage.

The operation that is being executed can include a data dependent branch operation. The branch operation can include two or more branches, where a branch is selected based on an operation such as an arithmetic or logical operation. In a usage example, a branch operation can determine the outcome of an expression such as A > B. If A is greater than B, then one branch can be taken. If A is less than or equal to B, then another branch can be taken.

In embodiments, the compiler can calculate a latency for the data dependent branch operation. Since execution of the at least two operations is impacted by latency, the latency can be scheduled into compute element operations. In order to further speed execution of a branch operation, sides of the branch can be precomputed prior to datum A and datum B being available. When the data is available, the expression can be computed (which is a form of predication), and the proper branch direction can be chosen. The untaken branch data and operations can be discarded, flushed, etc. In embodiments, the two or more data dependent branch operations can require a balanced number of execution cycles. The balanced number of execution cycles can reduce or eliminate idle cycles, stalling, and the like. In embodiments, the balanced number of execution cycles is determined by the compiler. In embodiments, the accessing, the providing, the loading, and the executing enable background memory accesses. The background memory access enables a control element to access memory independently of other compute elements, a controller, etc. In embodiments, the background memory accesses can reduce load latency. Load latency is reduced since a compute element can access memory before the compute element exhausts the data that the compute element is processing.

The system 700 can include a computer program product embodied in a non-transitory computer readable medium for task processing, the computer program product comprising code which causes one or more processors to perform operations of: accessing a two-dimensional (2D) array of compute elements, wherein each compute element within the array of compute elements is known to a compiler and is coupled to its neighboring compute elements within the array of compute elements; providing control for the array of compute elements on a cycle-by-cycle basis, wherein the control is enabled by a stream of wide control words generated by the compiler; loading an autonomous operation buffer with at least two operations contained in one or more control words, wherein the autonomous operation buffer is integrated in a compute element; setting a compute element operation counter, coupled to the autonomous operation buffer, wherein the compute element operation counter is integrated in the compute element; and executing the at least two operations, using the autonomous operation buffer and the compute element operation counter, wherein the operations complete autonomously from direct compiler control.

Each of the above methods may be executed on one or more processors on one or more computer systems. Embodiments may include various forms of distributed computing, client/server computing, and cloud-based computing. Further, it will be understood that the depicted steps or boxes contained in this disclosure’s flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript®, ActionScript®, assembly language, Lisp, Perl, Tel, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for task processing comprising:
accessing a two-dimensional (2D) array of compute elements, wherein each compute element within the array of compute elements is known to a compiler and is coupled to its neighboring compute elements within the array of compute elements;
providing control for the array of compute elements on a cycle-by-cycle basis, wherein the control is enabled by a stream of wide control words generated by the compiler;
loading an autonomous operation buffer with at least two operations contained in one or more control words, wherein the autonomous operation buffer is integrated in a compute element;
setting a compute element operation counter, coupled to the autonomous operation buffer, wherein the compute element operation counter is integrated in the compute element; and
executing the at least two operations, using the autonomous operation buffer and the compute element operation counter, wherein the operations complete autonomously from direct compiler control.

2. The method of claim 1 further comprising grouping a subset of compute elements within the array of compute elements.

3. The method of claim 2 wherein the subset comprises compute elements that are adjacent to at least two other compute elements within the array of compute elements.

4. The method of claim 3 further comprising loading additional autonomous operation buffers with additional operations contained in the one or more control words.

5. The method of claim 4 further comprising setting additional compute element operation counters, each coupled to an autonomous operation buffer of the additional operation buffers.

6. The method of claim 5 further comprising executing the additional operations cooperatively among the subset of compute elements.

7. The method of claim 6 wherein the additional operations complete autonomously from direct compiler control.

8. The method of claim 1 wherein the control words include control word bunches.

9. The method of claim 8 wherein the control word bunches provide operational control of a particular compute element.

10. The method of claim 9 wherein the operational control specifies arithmetic logic unit (ALU) connections.

11. The method of claim 9 wherein the operational control specifies compute element memory addresses and/or control.

12. The method of claim 1 wherein the compute element operation counter tracks cycling through the autonomous operation buffer.

13. The method of claim 12 further comprising generating a task completion signal.

14. The method of claim 13 wherein the task completion signal is based on a value in the compute element operation counter.

15. The method of claim 13 wherein the task completion signal is based on a decision calculation within a compute element.

16. The method of claim 1 wherein a control word in the stream of control words includes a data dependent branch operation.

17. The method of claim 16 wherein the compiler calculates a latency for the data dependent branch operation.

18. The method of claim 17 wherein the latency is scheduled into compute element operations.

19. The method of claim 1 wherein the autonomous operation buffer contains sixteen operational entries.

20. The method of claim 19 wherein the operational entries comprise compute element operations, compute element data paths, compute element ALU control, and compute element memory control.

21. The method of claim 1 wherein the wide control words comprise variable length control words.

22. A computer program product embodied in a non-transitory computer readable medium for task processing, the computer program product comprising code which causes one or more processors to perform operations of:
accessing a two-dimensional (2D) array of compute elements, wherein each compute element within the array of compute elements is known to a compiler and is coupled to its neighboring compute elements within the array of compute elements;
providing control for the array of compute elements on a cycle-by-cycle basis, wherein the control is enabled by a stream of wide control words generated by the compiler;
loading an autonomous operation buffer with at least two operations contained in one or more control words, wherein the autonomous operation buffer is integrated in a compute element;
setting a compute element operation counter, coupled to the autonomous operation buffer, wherein the compute element operation counter is integrated in the compute element; and
executing the at least two operations, using the autonomous operation buffer and the compute element operation counter, wherein the operations complete autonomously from direct compiler control.

23. A computer system for task processing comprising:
a memory which stores instructions;
one or more processors coupled to the memory, wherein the one or more processors, when executing the instructions which are stored, are configured to:
access a two-dimensional (2D) array of compute elements, wherein each compute element within the array of compute elements is known to a compiler and is coupled to its neighboring compute elements within the array of compute elements;
provide control for the array of compute elements on a cycle-by-cycle basis, wherein the control is enabled by a stream of wide control words generated by the compiler;
load an autonomous operation buffer with at least two operations contained in one or more control words, wherein the autonomous operation buffer is integrated in a compute element;
set a compute element operation counter, coupled to the autonomous operation buffer, wherein the compute element operation counter is integrated in the compute element; and
execute the at least two operations, using the autonomous operation buffer and the compute element operation counter, wherein the operations complete autonomously from direct compiler control.
